(19) United States
(12) Patent Application Publication
(10) Pub. No.: US 2004/0262424 A1
(43) Pub. Date: Dec. 30, 2004

(54) Fuel injection device for an internal combustion engine

(76) Inventors: Peter Boehland, Mabach (DE); Tobias Reiser, Ehningen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/492,412

(22) PCT Filed: Feb. 25, 2003
(86) PCT No.: PCT/DE03/00585

(30) Foreign Application Priority Data
Aug. 16, 2002 (DE) 10237585.2

(51) Int. Cl. F02M 47/02

(52) U.S. Cl. 239/88

(57) ABSTRACT

A fuel injection apparatus having a high-pressure fuel pump and a fuel injection valve for each cylinder. An electrically actuated control valve controls a connection of the pump working chamber to a discharge region. A first injection valve element controls at least one first injection opening and a second injection valve element guided inside the first injection valve element controls at least one second injection opening. Pressure in a control chamber acts on the second injection valve element at least indirectly in the closing direction. By means of a connection controlled by a valve, the control pressure chamber is connected to a pressure region in which a respective pressure increase and decrease are delayed in relation to pressure in the pump working chamber when the control valve respectively closes and opens. The valve that is acted on in the opening direction by the pressure prevailing in the pressure region and in the closing direction by the pressure prevailing in the pump working chamber.

### CROSS-REFERENCE TO RELATED APPLICATIONS

This application is a 35 USC 371 application of PCT/DE 03/00585 filed on Feb. 25, 2003.

### BACKGROUND OF THE INVENTION

1. Field of the Invention

The invention is directed to an improved fuel injection apparatus for an internal combustion engine, including a high-pressure fuel pump and a fuel injection valve connected to the fuel pump for each cylinder of the engine.

2. Description of the Prior Art

A fuel injection apparatus of the type with which this invention is concerned is known from DE 198 35 494 A1. This fuel injection apparatus has a high-pressure fuel pump and a fuel injection valve connected to it for each cylinder of the internal combustion engine. The high-pressure fuel pump has a pump piston that is driven into a stroke motion by the engine and delimits a pump working chamber connected to a pressure chamber of the fuel injection valve. The fuel injection valve has an injection valve element that controls at least one injection opening and, acted on by the pressure prevailing in the pressure chamber, can be moved in an opening direction counter to a closing force in order to open the at least one injection opening. An electrically actuated control valve at least indirectly controls a connection of the pump working chamber to a discharge region in order to control the fuel injection. When the pressure in the pump working chamber and therefore in the pressure chamber of the fuel injection valve reaches the opening pressure, then the injection valve element moves in the opening direction and opens the at least one injection opening. The injection cross section that is controlled by the injection valve element is always the same size. This does not permit an optimal fuel injection in all operating conditions of the internal combustion engine.

### SUMMARY OF THE INVENTION

The fuel injection apparatus according to the invention has the advantage over the prior art that by means of the at least one second injection opening, the second injection valve element can open or close an additional amount of injection cross section so that the injection cross section can be optimally adapted to the operating conditions of the engine. The valve successfully executes a reliable, rapid closing of the second injection valve element so that it is possible to avoid or at least to limit an undesirable increase in the injected fuel quantity at the transition from a fuel injection cycle in which only the first injection valve element opens to a fuel injection cycle in which the second injection valve element also opens.

Advantageous embodiments and modifications of the fuel injection apparatus according to the invention are disclosed. In one the pressure region is supplied with pressure in a simple manner without incurring additional expense.

### BRIEF DESCRIPTION OF THE DRAWINGS

Exemplary embodiments of the invention are described in detail herein below, with reference to the drawings, in which:

FIG. 1 shows a schematic longitudinal section through a fuel injection apparatus according to the invention for use in an internal combustion engine,

### DESCRIPTION OF THE PREFERRED EMBODIMENTS

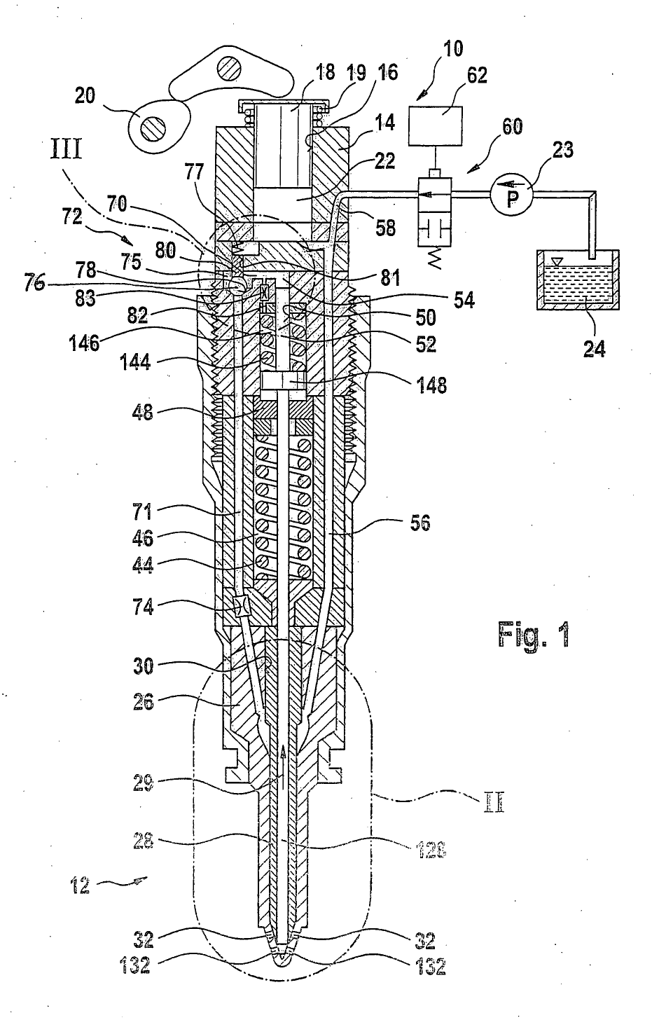

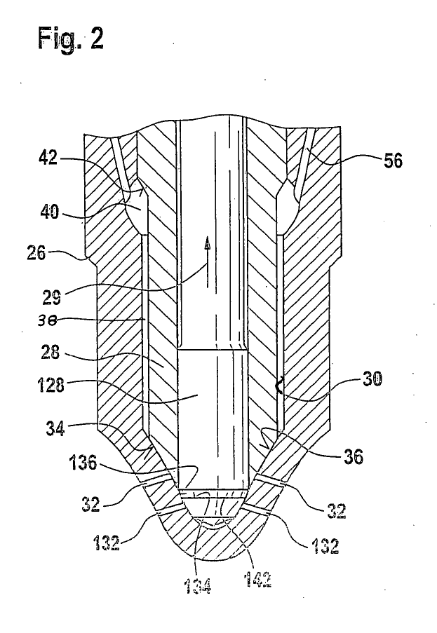

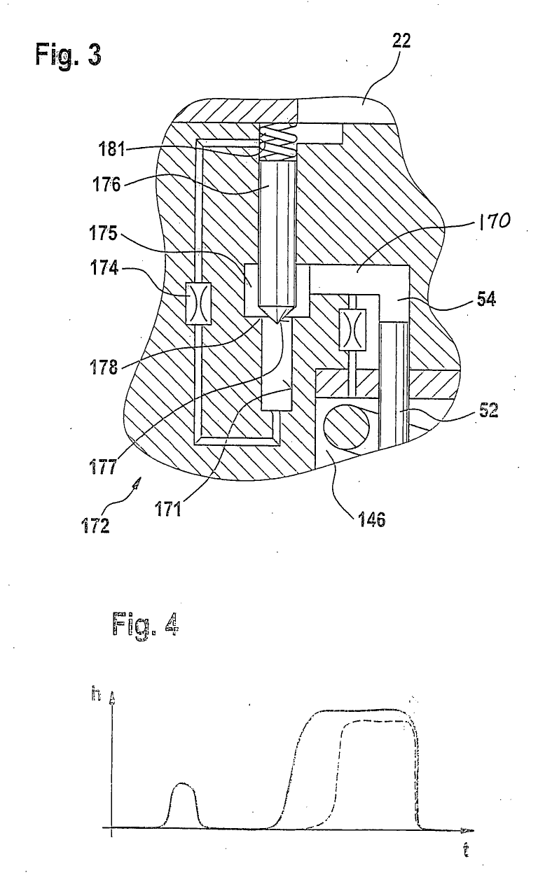

As shown in FIG. 1, the end of the first spring chamber 46 oriented away from the combustion chamber is adjoined by a second spring chamber 146 in the valve body 26, which contains a second closing spring 144 that acts on the second injection valve element 128 in the closing direction. The second spring chamber 146 is divided from the first spring chamber 46 by a wall 48 that is press-fitted into the valve body 26. The first closing spring 44 is supported against the wall 48 possibly by means of a precision washer. The second injection valve element 128 passes through a bore in the dividing wall 48 and protrudes into and through the second spring chamber 146. The second closing spring 144 is clamped between the end of the second spring chamber 146 and a spring plate 148 of the second injection valve element 128. The two spring chambers 46, 146 are each connected to a discharge region so that a low pressure prevails in them. A bore 50 with a smaller diameter than the second spring chamber 146 adjoins the end of the spring chamber 146 oriented away from the combustion chamber. A control piston 52, which is guided in a sealed fashion in the bore 50, is supported at one end against the second injection valve element 128, for example by means of the spring plate 148, and at its other end, delimits a control pressure chamber 54 in the bore 50.

The control pressure chamber 54 has a connection 70 to a pressure region 71, which is in turn connected to the pressure chamber 40. The connection 70 is controlled by a valve 72 and extends outward in an approximately radial direction starting from the bore 50 that contains the control pressure chamber 54. The pressure region 71 is embodied as a longitudinal bore 71 that extends through the valve body 26 to the pressure chamber 40, approximately parallel to the injection valve elements 28, 128. The longitudinal bore 71 preferably contains a throttle restriction 74. The longitudinal bore 71 consequently constitutes the pressure region that is supplied with pressure from the pressure chamber 40 and is decoupled from the latter by the throttle restriction 74. In a valve chamber 75 connected to the control pressure chamber 54, the valve 72 has a valve element 76 that can be embodied, for example as shown in FIG. 1, in the form of a ball and cooperates with a valve seat 78 embodied in the valve body 26 in order to control the connection 70. The valve seat 78 is formed at the transition from the valve chamber 75 to the longitudinal bore 71 that constitutes a part of the connection 70 in the valve body 26 and that has a smaller diameter than the valve chamber 75. The valve seat 78 is embodied as at least approximately conical. The valve element 76 is connected to a valve piston 80, which is guided in a sealed fashion in a bore 81 that adjoins the end of the valve chamber 75 oriented away from the valve seat 78. The bore 81 has a connection to the pump working chamber 22 that is not throttled. Consequently, the pressure prevailing in the longitudinal bore 71 acts on the valve element 76 in its opening direction, i.e. away from the valve seat 78, and the pressure prevailing in the pump working chamber 22, via the valve piston 80, acts on the valve element 76 in its closing direction, i.e. toward the valve seat 78. The cross sectional area of the valve element 76 enclosed by the valve seat 78 and the cross sectional area of the valve piston 80 disposed in the bore 81 are preferably at least approximately equal. It is also possible for a spring 77 to act on the valve element 76 in the closing direction toward the valve seat 78. The control pressure chamber 54 and the valve chamber 75 can have a connection 82 to the second spring chamber 146, via which they can then be connected to a discharge region. The connection 82 contains at least one throttle restriction 83.

The control unit 62 opens the control valve 60 to terminate the fuel injection cycle. The pressure in the pump working chamber 22 and in the pressure chamber 40 thus decreases so that the first injection valve element 28 is closed by the force of the first closing spring 44. When the control valve 60 opens, a rapid pressure decrease occurs in the pump working chamber 22 whereas the pressure decrease in the longitudinal bore 71 is delayed due to the throttle restriction 74 and the transit time of the pressure waves from the pump working chamber 22 to the valve element 76. Consequently, the relatively high pressure still prevailing in the longitudinal bore 71 exerts a force in the opening direction on the valve element 76 of the valve 72 that is greater than the force exerted in the closing direction by the pressure prevailing in the pump working chamber 22, which is already relatively quite low, thus causing the valve 72 to open. When the valve 72 is open, the control pressure chamber 54 is connected to the longitudinal bore 71 via the connection 70 so that an elevated pressure prevails in the control pressure chamber 54. The elevated pressure in the control pressure chamber 54 exerts a force via the control piston 52, which force adds to the force that the second closing spring 144 exerts on the second injection valve element 128 in the closing direction, thus causing the second injection valve element 128 to close rapidly. The pressure in the pressure chamber 40 decreases rapidly by means of the longitudinal bore 71 with the throttle restriction 74, the open valve 72, and the connection 82 to the throttle restriction 83.

FIG. 3 shows the fuel injection apparatus according to a modified embodiment in which, by contrast with the embodiment shown in FIG. 1 and explained above, the valve 172 controls a connection 170 of the control pressure chamber 54 to a pressure region 171 that is connected to the pump working chamber 22 instead of the pressure chamber 40. The pressure region 171 is embodied as a bore that contains the throttle restriction 174 in order to achieve a respective pressure increase and pressure decrease in the bore 171 that are delayed in relation to those respectively occurring in the pump working chamber 22. The valve 172 can be embodied the same as the one in the embodiment in FIG. 1 and can have a valve element in the form of a ball and a valve piston. Alternatively, the valve 172 can also have a piston-shaped valve element 176 that is guided in a sealed fashion in the bore 181. The valve element 176 protrudes into a valve chamber 175 and has a for example conical sealing surface 177 with which it cooperates with the valve seat 178 in order to control the connection 170. Alternatively, the valve element 176 can also have a for example spherically curved sealing surface 177. The valve chamber 175 adjoins the bore 171, which contains the throttle restriction 174 and feeds into the pump working chamber 22. The pressure prevailing in the bore 171 acts in the opening direction on the surface of the valve element 176 encompassed by the valve seat 178 and the pressure prevailing in the pump working chamber 22 acts in the closing direction on the surface of the valve element 176 disposed in the bore 181. When the control valve 60 closes, a pressure increase occurs in the bore 171, which is delayed in comparison to that occurring in the pump working chamber 22, thus causing the valve 172 to close. When the control valve 60 opens, a pressure decrease occurs in the bore 171, which is delayed in comparison to that occurring in the pump working chamber 22, thus causing the valve 172 to open. The function of the fuel injection apparatus is the same as the one described previously. The embodiment of the valve 172 with the piston-shaped valve element 176 can also be used in the embodiment of the fuel injection apparatus according to FIG. 1.

The foregoing relates to preferred exemplary embodiments of the invention, it being understood that other variants and embodiments thereof are possible within the spirit and scope of the invention, the latter being defined by the appended claims.

1-6. (canceled)

7. A fuel injection apparatus for an internal combustion engine, the apparatus comprising
a high-pressure fuel pump (10) and a fuel injection valve (12) connected to it for each cylinder of the engine,
the high-pressure fuel pump (10) having a pump piston (18) that is driven into a stroke motion by the engine and delimiting a pump working chamber (22) connected to a pressure chamber (40) of the fuel injection valve (12),
the fuel injection valve (12) having at least one first injection valve element (28) that controls at least one first injection opening (32) and can be moved in an opening direction (29) counter to a closing force by the pressure prevailing in the pressure chamber (40) in order to open the at least one first injection opening (32), and
an electrically actuated control valve (60) that at least indirectly controls a connection of the pump working chamber (22) to a discharge region (24),
the fuel injection valve (12) having a second injection valve element (128) guided so that it can slide inside the first injection valve element (28), the first injection valve element (28) being embodied as hollow,
the second injection valve element (128) controlling at least one second injection opening (132) and being supported for movement in an opening direction (29) counter to a second closing force by the pressure prevailing in a pressure chamber (40) in order to open the at least one second injection opening (132),
the second injection valve element (128) being acted on at least indirectly in a closing direction by the pressure prevailing in a fuel-filled control pressure chamber (54), the control pressure chamber (54) is connected by means of a connection (70; 170) controlled by a valve (72; 172), to a pressure region (71; 171) in which a respective pressure increase and pressure decrease are delayed in relation to those occurring in the pump working chamber (22) when the control valve (60) respectively closes and opens, and
the valve (72; 172) having a valve element (76, 80; 176) that is acted on in the opening direction by the pressure prevailing in the pressure region (71; 171) and is acted on in the closing direction by the pressure prevailing in the pump working chamber (22).

8. The fuel injection apparatus according to claim 7, wherein the pressure region (71) is connected to the pressure chamber (40) of the fuel injection valve (12) and is decoupled from it preferably by means of a throttle restriction (74).

9. The fuel injection apparatus according to claim 7, wherein the pressure region (171) is connected to the pump working chamber (22) and is decoupled from it by means of a throttle restriction (174).

10. The fuel injection apparatus according to claim 7, wherein the valve element (76) is connected to a valve piston (80) that is guided in a sealed fashion in a valve bore (81) and is acted on in the closing direction of the valve element (76) by the pressure prevailing in the pump working chamber (22).

11. The fuel injection apparatus according to claim 8, wherein the valve element (76) is connected to a valve piston (80) that is guided in a sealed fashion in a valve bore (81) and is acted on in the closing direction of the valve element (76) by the pressure prevailing in the pump working chamber (22).

12. The fuel injection apparatus according to claim 9, wherein the valve element (76) is connected to a valve piston (80) that is guided in a sealed fashion in a valve bore (81) and is acted on in the closing direction of the valve element (76) by the pressure prevailing in the pump working chamber (22).

13. The fuel injection apparatus according to claim 7, wherein the second injection valve element (128) is connected to a control piston (52) that delimits the control pressure chamber (54).

14. The fuel injection apparatus according to claim 8, wherein the second injection valve element (128) is connected to a control piston (52) that delimits the control pressure chamber (54).

15. The fuel injection apparatus according to claim 9, wherein the second injection valve element (128) is connected to a control piston (52) that delimits the control pressure chamber (54).

16. The fuel injection apparatus according to claim 10, wherein the second injection valve element (128) is connected to a control piston (52) that delimits the control pressure chamber (54).

17. The fuel injection apparatus according to claim 11, wherein the second injection valve element (128) is connected to a control piston (52) that delimits the control pressure chamber (54).

18. The fuel injection apparatus according to claim 12, wherein the second injection valve element (128) is connected to a control piston (52) that delimits the control pressure chamber (54).

19. The fuel injection apparatus according to claim 7, wherein the control pressure chamber (54) is connected to a discharge region at least indirectly via a connection (82) that contains a throttle restriction (83).

20. The fuel injection apparatus according to claim 8, wherein the control pressure chamber (54) is connected to a discharge region at least indirectly via a connection (82) that contains a throttle restriction (83).

21. The fuel injection apparatus according to claim 9, wherein the control pressure chamber (54) is connected to a discharge region at least indirectly via a connection (82) that contains a throttle restriction (83).

22. The fuel injection apparatus according to claim 10, wherein the control pressure chamber (54) is connected to a discharge region at least indirectly via a connection (82) that contains a throttle restriction (83).

23. The fuel injection apparatus according to claim 11, wherein the control pressure chamber (54) is connected to a discharge region at least indirectly via a connection (82) that contains a throttle restriction (83).

24. The fuel injection apparatus according to claim 12, wherein the control pressure chamber (54) is connected to a discharge region at least indirectly via a connection (82) that contains a throttle restriction (83).

25. The fuel injection apparatus according to claim 13, wherein the control pressure chamber (54) is connected to a discharge region at least indirectly via a connection (82) that contains a throttle restriction (83).

26. The fuel injection apparatus according to claim 14, wherein the control pressure chamber (54) is connected to a discharge region at least indirectly via a connection (82) that contains a throttle restriction (83).
